(19) United States
(12) Patent Application Publication
(10) Pub. No.: US 2010/0075146 A1
(43) Pub. Date: Mar. 25, 2010

(54) SIZING COMPOSITION FOR MINERAL FIBERS COMPRISING A PHENOLIC RESIN, AND RESULTING PRODUCTS

(75) Inventors: Jerome Douce, Paris (FR); Alexandra Dekoninck, Ezanville (FR); Veronique Chopin, Bruyeres sur Oise (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN ISOVER, Courbevoie (FR)

(21) Appl. No.: 12/519,977

(22) PCT Filed: Dec. 19, 2007
(86) PCT No.: PCT/FR2007/052561

§ 371 Date: Aug. 31, 2009

(30) Foreign Application Priority Data
Dec. 22, 2006 (FR) 0655878

(51) Int. Cl. C08K 5/21; B32B 27/02; G10K 11/00

(52) U.S. Cl. 428/394; 524/211; 181/175

(57) ABSTRACT

The present invention relates to a sizing composition for mineral fibers comprising a phenolic resin, urea, a crosslinking catalyst, and optionally additives, characterized in that the crosslinking catalyst is a mixture of ammonium sulfamate and ammonium sulfate.

Another subject of the invention is insulation products based on mineral fibers, in particular fine fibers, bonded by means of the aforementioned sizing composition.

The invention relates to the manufacture of insulation products formed from mineral fibers, more particularly to a sizing composition for such fibers, especially fine fibers.

Insulation products based on mineral fibers may be formed from fibers obtained by various processes, for example according to the known technique of internal or external centrifugal fiberizing. The centrifugation consists in introducing molten material (in general glass or rock) into a spinner that has a multitude of small holes, the material being projected against the peripheral wall of the spinner under the action of the centrifugal force and escaping therefrom in the form of filaments. On leaving the spinner, the filaments are attenuated and entrained by a high-velocity, high-temperature gas stream to a receiving member in order to form a web of fibers.

To assemble the fibers together and provide the web with cohesion, the fibers, on leaving the spinner, are sprayed with a sizing composition containing a thermosetting resin. The web of fibers coated with the size is subjected to a heat treatment (at a temperature above 100° C.) so as to carry out the polycondensation of the resin and thus obtain a thermal and/or acoustic insulation product having specific properties, especially dimensional stability, tensile strength, thickness recovery after compression and uniform color.

The sizing composition is made up of the resin (in general in the form of an aqueous solution), urea, a crosslinking catalyst, optionally additives such as silanes and mineral oils, and water.

The most commonly used thermosetting resins are phenolic resins that belong to the family of resols. Resols are obtained by condensation of phenol and formaldehyde, in the presence of a basic catalyst, in a formaldehyde/phenol molar ratio generally greater than 1 so as to promote the reaction between the phenol and the formaldehyde and to reduce the content of residual phenol in the resin.

Urea is introduced into the sizing composition to trap the free formaldehyde in the form of urea-formaldehyde condensates.

The catalyst may be a strong acid, or an ammonium salt of such an acid that acts as a latent catalyst, for example an ammonium salt of sulfamic acid, oxalic acid, sulfuric acid, methanesulfonic acid, toluenesulfonic acid and phenolsulfonic acid (U.S. Pat. No. 5,952,440). Usually, the catalyst is ammonium sulfate. Although it proves very effective in terms of crosslinking the resin, ammonium sulfate may however result in premature gelling of the resin (pregelling) which affects the quality of the final insulation product, especially its mechanical properties which are reduced due to the fact that the resin cannot correctly bond the fibers. Thus, ammonium sulfate is generally used as a mixture with an inhibitor such as aqueous ammonia whose role is to keep the sizing composition at a basic pH (equal to or greater than 7) so that the latter remains stable until the thermal crosslinking treatment of the resin.

Since the regulations with regard to environmental protection are becoming stricter, manufacturers of insulation products are obliged to seek solutions that make it possible to reduce the undesirable emissions generated by this type of sizing composition.

It is known that, under the temperature conditions applied to the treatment of the web of sized fibers in the oven, the urea-formaldehyde condensates are not thermally stable and decompose releasing formaldehyde and urea, which is in turn degraded to ammonia. It is also assumed that the aqueous ammonia is capable of decomposing to ammonia gas under the same conditions.

There is therefore a need to provide sizing compositions which can crosslink at a lower temperature in order to limit release of pollutants into the atmosphere.

Furthermore, products that incorporate fine fibers have appeared recently which have improved insulation properties, in particular a thermal conductivity 2 of less than 40 mW (m·K).

The production of such products is, however, rendered difficult by the fact that the web of sized fibers has a high insulating capacity and that consequently the temperature at the heart of the web is insufficient to enable the complete crosslinking of the resin. One way of overcoming this drawback consists in increasing the residence time of the web in the oven, but this translates into a decrease in productivity and an additional cost as regards heating of the oven.

There is also a need to provide sizing compositions which can crosslink at a lower temperature in order to enable insulation products formed from fine mineral fibers to be produced under standard operating conditions, without having to lengthen the treatment time of the web in the oven.

In order to achieve these objectives, the present invention provides a sizing composition comprising a thermosetting resin, urea and a crosslinking catalyst, and optionally additives, which is characterized in that said catalyst is a mixture of ammonium sulfamate and ammonium sulfate.

Another subject of the invention is the use of the sizing composition to bind the mineral fibers with a view to forming thermal and/or acoustic insulation products having a low thermal conductivity λ, in particular of less than 40 mW/(m·K), and the products thus obtained.

According to the invention, the sizing composition combines, as a crosslinking catalyst for the resin, ammonium sulfamate and ammonium sulfate.

The combination of ammonium sulfamate and ammonium sulfate has the main advantage of lowering the crosslinking temperature of the resin without however increasing the risk of the resin gelling on the fibers before the heat treatment that aims to obtain the definitive bonding of the fibers in the final insulation product. Unexpectedly, a synergistic effect has been observed linked to the combination of the two aforementioned compounds which is expressed by maintaining the pregelling time at a level close to that which is obtained by using ammonium sulfamate alone, or even under certain conditions described later on, by an increase of the pregelling time.

Moreover, said combination makes it possible to give the sizing composition a stability such that it is not necessary to add aqueous ammonia, which helps to lower the emissions of ammonia in the oven.

As a general rule, the content of ammonium sulfamate and ammonium sulfate varies from 2 to 8% by weight of the resin and urea solids, preferably from 2.5 to 6% and advantageously from 2.6 to 4.2%.

Preferably, the molar ratio of ammonium sulfamate to ammonium sulfate varies from 0.25 to 0.75, advantageously from 0.40 to 0.60.

The thermosetting resin according to the invention is chosen from phenolic resins obtained by reaction of a phenolic compound and an aldehyde in the presence of a basic catalyst, in an aldehyde/phenolic compound molar ratio greater than 1.

Preferably, the phenolic compound is phenol and the aldehyde is formaldehyde.

The thermosetting resin may comprise one or more of the aforementioned phenolic resins.

Such resins may be prepared according to a temperature cycle comprising three phases: a heating phase, a temperature hold and a cooling phase.

In the first phase, the aldehyde and the phenolic compound are reacted in the presence of a basic catalyst by gradually heating to a temperature between 60 and 75° C., preferably to around 70° C. The aldehyde/phenolic compound molar ratio is greater than 1, preferably varies from 2 to 5, and advantageously from 2.3 to 4.2.

The catalyst may be chosen from the catalysts known to a person skilled in the art, for example triethylamine, lime (CaO) and alkali or alkaline-earth metal hydroxides, for example sodium, potassium, calcium or barium hydroxides. Sodium hydroxide and lime are preferred.

The amount of catalyst varies from 2 to 15%, preferably from 5 to 9%, and advantageously from 6 to 8% by weight relative to the initial weight of phenol.

In the second phase, the temperature of the reaction mixture, which is reached after heating the reaction mixture (end of the first phase), is maintained until the degree of conversion of the phenol is at least equal to 90%, preferably at least 93% and advantageously at least 97%.

The expression “degree of conversion of the phenolic compound” is understood to mean the percentage of the phenolic compound that has participated in the condensation reaction with the aldehyde relative to the initial content of phenolic compound.

The third, cooling phase occurs at a stage of the condensation which corresponds to a resin which may still be diluted by water (dilutability greater than 1000%). The final temperature of the cooled mixture is around 20 to 25° C.

The “dilutability” is defined here as the volume of deionized water which it is possible, at a given temperature, to add to one volume unit of the aqueous resin solution before the appearance of permanent haze. It is generally considered that a resin is capable of being used in a sizing composition when its dilutability is greater than or equal to 1000%, at 20° C.

During the third phase, it is possible, from the start of the cooling (at high temperature) and up to the complete cooling (at low temperature), to add a compound containing a nitrogen atom which may react with the free aldehyde, for example urea and/or one (some) alkanol amine(s).

The resin obtained is neutralized until a pH less than or equal to 9, preferably less than or equal to 8.5 and advantageously less than or equal to 8 is obtained by addition of an acid, preferably sulfuric acid or sulfamic acid, in order to stop the condensation reactions of the phenolic compound and the aldehyde. Particularly advantageously, the pH is greater than or equal to 4.

The resins obtained by reaction of phenol and formaldehyde have a free phenol content less than or equal to 2% of the total weight of liquid and a free formaldehyde content less than or equal to 10% of the total weight of liquid.

The phenolic resin has a dilutability, measured at 20° C., a least equal to 1000%.

It is possible to add, to the phenolic resin obtained, urea in a sufficient amount to react with the free aldehyde which may represent up to 50 parts by weight per 100 parts by weight of resin and urea, preferably from 20 to 45 parts by weight.

The addition of urea is generally carried out by simple mixing with the phenolic resin, preferably at ambient temperature, especially between 20 and 25° C.

According to a first variant, the urea is added to the resin to form a “premix” which may be kept for a certain time before being mixed with the other constituents to form the sizing composition applied to the mineral fibers. The urea contained in the premix may represent all of the urea to be added, or only one part, with the rest being introduced during the manufacture of the sizing composition.

According to a second variant, the preparation of the sizing composition is carried out extemporaneously, by simple mixing of the urea and the other constituents.

The sizing composition according to the invention may moreover comprise the additives below in the following proportions calculated on the basis of 100 parts by weight of resin and urea solids:
0 to 2 parts of silane, in particular an aminosilane; and
0 to 20 parts of oil, generally 4 to 15 parts.

The role of the additives is known and briefly recalled: the silane is an agent for coupling between the fibers and the resin, and also acts as an anti-aging agent; the oils are anti-dust and hydrophobic agents.

The sizing composition may also comprise at least one saccharide which has the role of reducing the amount of phenolic resin in the size in order to reduce the cost. The nature of the saccharide and its content in the sizing composition are chosen so as to not substantially modify the properties of the binder in the final insulation product. Saccharides of natural origin, for example molasses, especially sugar cane or beet, are preferred. The saccharide may be added to the sizing composition in an amount which may range up to 15 parts by weight calculated on the basis of 100 parts by weight of resin, urea and saccharide solids.

The sizing composition may be applied to mineral fibers, especially glass or rock fibers.

The acoustic and/or thermal insulation products obtained from these sized fibers also constitute a subject of the present invention. In particular, the application of the sizing composition to fine fibers makes it possible to obtain insulation products having a thermal conductivity λ of less than 40 mW/(m·K).

The examples which follow make it possible to illustrate the invention without however limiting it.

In the examples, the following methods of analysis are used:
the crosslinking temperature is determined by the so-called Dynamic Mechanical Analysis (DMA) method, which makes it possible to characterize the viscoelastic behavior of a polymer material. The procedure is as follows: a sample of glass paper is impregnated with the aqueous solution to be tested (30% by weight of solids) then it is clamped horizontally between two fixed jaws. An oscillating element is applied against the upper face of the sample and connected to a device for measuring the stress as a function of the strain applied, which makes it possible to calculate the elastic modulus E. The sample is heated to a temperature that varies from 30 to 250° C. at a rate of 4° C./minute. From the measurements, the curve of the variation in elastic modulus E (in MPa) as a function of temperature (in ° C.) is plotted. The temperature at the point of inflexion (dE/dTₘₐₓ) of the curve corresponds to the crosslinking temperature, expressed in ° C.;
the pregelling time is measured as follows: an aqueous solution containing 30% by weight of solids is placed in a rheometer of plane-plane configuration and the viscosity is measured while oscillating under a constant strain (0.1%) at 80° C. (isothermal). The pregelling time, in seconds, is the time required to obtain a viscosity equal to 8 Pa·s; and
the tensile strength is measured according to the ASTM C 686-71T standard on a sample cut by punching from the insulation product. The sample has the shape of a torus with a length of 122 mm, a width of 46 mm, a radius of curvature of the cut of the outer edge equal to 38 mm and a radius of curvature of the inner edge equal to 12.5 mm. The sample is placed between two cylindrical mandrels of a test machine, of which one mandrel is mobile and moves at a constant rate. The force F (in N) to break the sample is measured and the tensile strength is calculated by the ratio of the breaking force F to the mass of the sample, expressed in N/g.

### EXAMPLE 1

### Sizing Composition for Extemporaneous Use

A phenolic resin was prepared by reaction of formaldehyde and phenol (formaldehyde/phenol molar ratio equal to 3.2) in the presence of a catalyst (NaOH; 6 wt % relative to the phenol) under the temperature conditions described above until a degree of phenol conversion greater than 97% was obtained. The resin was then neutralized to pH=7.3 by sulfamic acid.

70 parts by weight of phenolic resin and 30 parts by weight of urea were mixed. Water was added to the mixture so as to obtain a solids content equal to 30%.

From the mixture, several compositions were created by adding the following compounds:
Composition A: 2.5 parts of ammonium sulfamate+2.5 parts of ammonium sulfate;
Composition B: 2.5 parts of ammonium sulfamate;
Composition C: 2.5 parts of ammonium sulfate;
Composition D: 5 parts of ammonium sulfamate;
Composition E: 5 parts of ammonium sulfate; and
Composition F: 1 part of ammonium sulfate+2 parts of a 20 wt % ammonium hydroxide solution.

The measurements of the crosslinking temperature and of the pregelling time of the aforementioned compositions are given in Table 1 below.

TABLE 1

| | Crosslinking | Pregelling time |
|---|---|---|
| Composition | temperature (° C.) | (seconds) |
| A | 142 | 700 |
| B | 148 | 430 |
| C | 146 | 260 |
| D | 141 | 300 |
| E | 142 | 100 |
| F (reference) | 154 | 1250 |

Composition A combining ammonium sulfamate and ammonium sulfate has a significantly increased pregelling time (700 seconds) compared to that of composition B (430 seconds) and composition C (260 seconds), whereas it was expected to have an intermediate value between these two values. This denotes a synergistic effect between the ammonium sulfamate and the ammonium sulfate. Even though the pregelling time of composition A is reduced by half compared to the reference composition F, it remains sufficiently high to be applied to the fibers under the standard conditions for producing insulation products.

The crosslinking temperature of composition A is reduced relative to compositions B and C, respectively by 6 and 4° C., and lies at the same level as that of compositions D and E having an equivalent catalyst content. The reduction in temperature is large (12° C.) relative to the reference composition F.

### EXAMPLE 2

### Sizing Composition Using a “Premix” of Phenolic Resin and Urea

63 parts by weight of the phenolic resin from Example 1 and 37 parts by weight of urea were mixed. Water was added to the mixture so as to obtain a solids content equal to 30%, then the mixture was left stirring for at least 48 hours.

From the mixture, several compositions were produced by adding the following compounds:
Composition G: 1 part of ammonium sulfamate+1 part of ammonium sulfate;
Composition H: 2.1 parts of ammonium sulfamate+2.1 parts of ammonium sulfate;
Composition I: 2.1 parts of ammonium sulfamate;
Composition J: 2.1 parts of ammonium sulfate;
Composition K: 4.2 parts of ammonium sulfamate;
Composition L: 4.2 parts of ammonium sulfate; and
Composition M: 1.1 parts of ammonium sulfate+0.5 part of a 20 wt % ammonium hydroxide solution.

The measurements of the crosslinking temperature and of the pregelling time of the aforementioned compositions are given in Table 2 below.

TABLE 2

| | Crosslinking | Pregelling time |
|---|---|---|
| Composition | temperature (° C.) | (seconds) |
| G | 150 | 4400 |
| H | 145 | 4700 |
| I | 156 | 5000 |
| J | 155 | 1860 |
| K | 145 | 3500 |
| L | 144 | 1300 |
| M (reference) | 158 | 5000 |

Composition G comprising a mixture of ammonium sulfamate and ammonium sulfate has a lower crosslinking temperature relative to compositions I and J that respectively contain ammonium sulfamate and ammonium sulfate at an equivalent total amount, while retaining a high pregelling time, comparable to that of composition I.

The increase in the total amount of ammonium sulfamate and ammonium sulfate in composition H makes it possible to reduce the crosslinking temperature by 5° C. and increase the pregelling time by 300 seconds relative to composition G.

The crosslinking temperature of composition H is comparable to that of compositions K and L whereas the pregelling time is considerably higher than the highest pregelling time (composition K), which demonstrates a synergy between the ammonium sulfamate and the ammonium sulfate.

Compositions G and H have a pregelling time comparable to the reference composition M and a crosslinking temperature reduced by 8 and 13° C. respectively.

### EXAMPLE 3

### Manufacture of an Insulation Product Based on Glass Fibers

A mixture of the phenolic resin from Example 1 (63 parts by weight) and urea (37 parts by weight) was prepared under the conditions from Example 2, to which the following compounds were added:
Composition N: 1.7 parts of ammonium sulfamate+1.7 parts of ammonium sulfate+0.5 part of silane (Silquest A-1100® sold by GE Silicones); and
Composition O: 1.1 parts of ammonium sulfate+0.4 part of a 20 wt % ammonium hydroxide solution+0.5 part of silane (Silquest A-1100® sold by GE Silicones).

These sizing compositions were used in a line for manufacturing insulation products based on glass wool: the sizing compositions were diluted so as to be sprayed separately over glass filaments formed in a spinner, before being collected on a conveyor belt in the form of a web which was transported into an oven equipped with fans blowing air at 250 or 265° C. to ensure the crosslinking of the size.

At the outlet of the oven chimney, the amount of ammonia released during the thermal treatment of the web was measured.

The products obtained had a thickness of 160 mm, a density of 19.5 kg/m³ and a loss on ignition (LOI) equal to 7%. The tensile strength and the thermal conductivity λ of the products were measured.

The results of the measurements are given in Table 3 below.

TABLE 3

| | Oven | Thermal | Tensile | Ammonia |
|---|---|---|---|---|
| | temperature | conductivity | strength | emissions |
| Composition | (° C.) | λ mW/(m · K) | (N/g) | (mg/Nm³) |
| N | 265 | 33.6 | 2.50 | 33 |
| N | 250 | 33.6 | 2.89 | n.d. |
| O | 265 | 33.6 | 2.55 | 169 |
| (reference) | | | | |

n.d.: not determined

The insulation product obtained from the sizing composition N crosslinked at 265° released an amount of ammonia that was around 5 times lower than the product treated with the reference composition O.

Crosslinking of the sizing composition N at a temperature of 250° C. was satisfactory; the product obtained had an improved tensile strength (+17.25%) relative to the product obtained with the reference sizing composition O and also relative to the product coated with the same sizing composition treated at the temperature of 265° C.

### EXAMPLE 4

### Manufacture of an Insulation Product Based on Glass Fibers

A mixture of the phenolic resin from Example 1 (63 parts by weight) and urea (37 parts by weight) was prepared under the conditions from Example 2, to which the following compounds were added:
Composition P: 2 parts of ammonium sulfamate+2 parts of ammonium sulfate+0.5 part of silane (Silquest A-1100® sold by GE Silicones); and Composition Q (reference): 1.1 parts of ammonium sulfate+0.4 part of a 20 wt % ammonium hydroxide solution+0.5 part of silane (Silquest A-1100° sold by GE Silicones).

Each sizing composition was applied separately to the glass filaments under the conditions from Example 3, the temperature in the oven being equal to 265° C.

The products obtained had a thickness of 180 mm, a density equal to 13.4 kg/m³, a loss on ignition (LOI) equal to 7% and a thermal conductivity λ equal to 37.0 mW/(m·K).

The insulation products obtained from the sizing compositions P and Q had a tensile strength equal to 3.8 and 3.1 N/g respectively.

The improvement in the tensile strength of the product treated with the sizing composition P (+22.6%) denotes a better crosslinking ability of the size during the thermal treatment.

### EXAMPLE 5

### Manufacture of a High-Density Insulation Product Based on Glass Fibers

A mixture comprising the phenolic resin from Example 1 (59.5 parts by weight) and urea (25.5 parts by weight) was prepared. Water was added to the mixture so as to obtain a solids content between 30 and 60%, then the mixture was left stirring for at least 8 hours. Next, molasses (15 parts by weight; sold by Agrokommerz) were added.

The following compounds were added to the aforementioned mixture:
Composition P: 1.3 parts of ammonium sulfamate+1.3 parts of ammonium sulfate; and
Composition Q: 1 part of ammonium sulfate+3 parts of a 20 wt % ammonium hydroxide solution.

The sizing compositions were used in a line for the industrial manufacture of insulation products based on glass wool under the conditions from Example 3 (temperature of the air in the oven: 250° C.)

The products obtained had a density equal to 75.6 kg/m³ and a loss on ignition (LOI) equal to 7.7%.

At the outlet of the oven chimney, the amount of ammonia released during the thermal treatment of the glass wool was measured.

| Composition | Ammonia (mg/Nm³) |
|---|---|
| P | 45 |
| Q (reference) | 90 |

The addition of the mixture of ammonium sulfamate and ammonium sulfate into the composition P made it possible to reduce the ammonia emissions by 50%.

### EXAMPLE 6

### Sizing Composition Using a “Premix” of Phenolic Resin and Urea

A phenolic resin was prepared by reaction of formaldehyde and phenol (formaldehyde/phenol molar ratio equal to 4) in the presence of a catalyst (NaOH: 5% by weight relative to the phenol), the second phase mentioned in the description being carried out at 70° C. for 60 minutes. The resin was then neutralized to pH=7.4 by sulfuric acid.

67 parts by weight of the phenolic resin and 33 parts by weight of urea were mixed. Water was added to the mixture so as to obtain a solids content between 30 and 60%, then the mixture was left stirring for at least 8 hours.

From the mixture, the compositions below were produced by adding the following compounds:
Composition R: 1.3 parts of ammonium sulfamate+1.3 parts of ammonium sulfate; and
Composition S: 1.8 parts of ammonium sulfate+2.5 parts of a 20 wt % ammonium hydroxide solution.

Compositions R and S (reference) had a pregelling time equal to 2035 seconds and 2090 seconds respectively. These pregelling times are considered to be similar.

Compositions R and S were crosslinked at 180° C. and the amount of ammonia emitted during the crosslinking was measured:

| | Ammonia (g/kg of |
|---|---|
| Composition | crosslinked size) |
| R | 0.86 |
| S (reference) | 2.09 |

The addition of the mixture of ammonium sulfamate and ammonium sulfate into the composition R made it possible to reduce the ammonia emissions by 58.85%.

1. A sizing composition for mineral fibers chosen from rock and glass fibers, comprising a phenolic resin, urea, a resin crosslinking catalyst, and optionally additives, wherein the catalyst comprises a mixture of ammonium sulfamate and ammonium sulfate.

2. The composition as claimed in claim 1, wherein the content of ammonium sulfamate and ammonium sulfate varies from 2 to 8% by weight of the resin and urea solids.

3. The composition as claimed in claim 2, wherein the content varies from 2.5 to 6%.

4. The composition as claimed in claim 1, wherein the molar ratio of ammonium sulfamate to ammonium sulfate varies from 0.25 to 0.75.

5. The composition as claimed in claim 1, wherein said phenolic resin is obtained by the reaction of a phenolic compound and an aldehyde in the presence of a basic catalyst, said resin having an aldehyde/phenolic compound molar ratio greater than 1.

6. The composition as claimed in claim 5, wherein the aldehyde/phenolic compound molar ratio varies from 2 to 5.

7. The composition as claimed in claim 5, wherein the phenolic compound is phenol and the aldehyde is formaldehyde.

8. The composition as claimed in claim 7, wherein the resin has a free phenol content less than or equal to 2% of the total weight of liquid and a free formaldehyde content less than or equal to 10% of the total weight of liquid.

9. The composition as claimed in claim 1, wherein the urea represents up to 50 parts by weight per 100 parts by weight of resin and urea.

10. The composition as claimed in claim 1, wherein it moreover comprises the additives below in the following proportions calculated on the basis of 100 parts by weight of resin and urea solids:
0 to 2 parts of silane; and
0 to 20 parts of oil.

11. A thermal and/or acoustic insulation product having a thermal conductivity λ of less than 40 mW/(m·K) comprising the sizing composition as claimed in claim 1.

12. A thermal and/or acoustic insulation product based on mineral fibers chosen from glass and rock fibers, wherein the fibers are coated with a sizing composition as claimed in claim 1.

13. The product as claimed in claim 12, wherein it has a thermal conductivity λ less than or equal to 40 mW/(m·K).
